(19) United States
(12) Patent Application Publication
(10) Pub. No.: US 2008/0189497 A1
(43) Pub. Date: Aug. 7, 2008

(54) System for Persisting Digital Multimedia Files onto a Digital Device

(76) Inventor: Matthew Justin Hunter, Egg Harbor Twp., NJ (US)

Correspondence Address: Matthew Hunter, 2432 Town Court N, Lawrenceville, NJ, 08648, US

(21) Appl. No.: 11/671,447

(22) Filed: Feb. 5, 2007

(51) Int. Cl. G06F 12/02

(52) U.S. Cl. 711/162

(57) ABSTRACT

A system and method for automatically persisting digital multimedia data from an external memory unit (flash disk or equivalent medium), or simply a multimedia chip, to a digital multimedia device upon connection. Digital multimedia data is stored onto the multimedia chip, the digital multimedia device has its own an internal disk drive, when the two devices are coupled, the digital multimedia data stored on on the external memory unit chip is decrypted, automatically persisted, and stored onto the digital multimedia device's internal disk drive. If the digital multimedia device fails to decrypt the multimedia chip, it enables the multimedia data to be played back on the digital multimedia device. The storage and distribution of the digital multimedia data from an external disk drive to a digital multimedia device creates a new means of distribution for digital multimedia data.

### FIELD OF THE INVENTION

The present invention relates in general to the field of digital multimedia devices and digital multimedia, and in particular, the means of distribution of multimedia files such as audio/music, still images, video, text, and music to these devices which include, but are not limited to digital audio players, cell phones, PDAs, portable audiobook players, and portable video devices.

### BACKGROUND OF THE INVENTION

In the past few years digital data compression and the use of digital multimedia devices such as music/camera/video players and recorders has been developing rapidly. Along with its development, sizes have continued to become smaller, while their internal hard drives (or like mediums) have become significantly larger. As a result, these devices have become increasingly popular. While these devices have been advancing and becoming popular, the means for transferring digital data to the device has changed very little.

Present systems and methods for transmitting digital data onto a digital multimedia device are typically done through connecting the said device to a host system or purchasing songs wirelessly through the internet. In order to transfer media onto the device the user must first purchase the media that is to be copied to the device. This can be done by multiple methods.

One method employed is, the user buys the media stored on a compact disc or digital video disk (or like format) and goes through a process of storing the files onto the device. This method is inefficient because the user must first obtain the compact disc, convert the files on the disk into digital files, then the user must connect the device to a host system, select the digital files to be copied onto the device, and finally automatically persist the digital data files to the device's hard drive (or like medium). Currently in most implementations, this method use Digital Rights Management (DRM) to control the distribution and pirating of these files. In its current state, DRM has said to been flawed and has many complaints.

Another method employed is, the user purchases already converted digital media through a computer that is connected to the internet, and then the user must connect the device to the computer, the user then selects which songs to download to the device's hard drive, and finally automatically persists the digital data files to the device's hard drive (or like medium).

These current methods have flaws. A flaw of the present systems and method is the need for connecting the device to a computer in order to transfer media onto the said device. This method makes it difficult for a user without a computer to transfer digital media onto a device. Furthermore, the current method closes the option of purchasing a digital multimedia device to those consumers who do not own a computer and those consumers who feel they are not “computer savvy” enough to transfer digital data onto the said device. Because of this, a potential consumer may choose to purchase a technologically older device, such as a compact disc player, over the present, more advanced, device. Another flaw is the difficulty in tracking the source of the digital data. In the current method, it is very difficult to tell whether or not the source of the digital data was a legal or illegal one. An easier, more controlled, more automated, and secure system for placing music onto a user's digital multimedia device is therefore needed.

### SUMMARY OF THE INVENTION

The present invention overcomes the problems noted above and satisfies the needs in this field for a system and method of persisting digital multimedia data from an external disk drive to a users digital multimedia device. As used in this application, the term digital multimedia device refers to a device which can play or store and play multimedia files, such as an mp3 player, personal computer, portable audio player, cell phones, PDA, or portable video player where multimedia content can be either played or both stored and played. The present invention is directed to the storage of digital data to a multimedia chip, once the multimedia chip is connected to a device, the files on the multimedia chip are authenticated using an automation program and either automatically transferred to the device or are enabled to be played by the device. As used in this application, a multimedia chip is flash disk drive (or equivalent medium) where the automation program is located.

The multimedia chip utilizes the power from the device in which it is connected to. This is the most efficient way to maximize on form factor and cost. Another advantage is that it increases the chip's life span. Additionally, this enables the automation program to load automatically when the multimedia chip receives power. When the multimedia chip is connected to a device, the automation program is booted and the process begins.

Automation program located on the multimedia chip enables the multimedia chip to detect what type the device is. In order to be decrypted, the automation program needs a key code. The key code is used as a form of DRM, and resides on the digital multimedia device. When the multimedia chip is connected to the digital multimedia device, the automation program communicates with the device, if the key code is still valid on the device it will automatically persists the content from the multimedia chip onto the digital multimedia device. Once the persistence occurs, the digital multimedia device's key code is added to the key code list stored on the multimedia chip. The automation program can include an install threshold to limit how many digital multimedia devices the multimedia content can be stored on.

Before the multimedia chip automatically persists the content onto the hard drive (or like medium) of the digital multimedia device, it uses the key code to check if that multimedia chip has already been persisted on other user's digital multimedia devices. If the key code on the multimedia chip does not match that of the digital multimedia device and the multimedia chip key code threshold has already been reached, the key code on the multimedia chip will not unlock the files to be transferred. In this case, the multimedia chip will still be will allow for the content to be decrypted for playback mode only. In playback only mode, as long as the multimedia chip is coupled to the digital multimedia device, the user can play the content of the multimedia chip using the digital multimedia device.

Playback only mode can also be used when the multimedia chip is connected to a host system, personal computer, vehicle, or other future system. When connected to a host system, playback only mode also allows for the user to burn the content of the multimedia chip onto a compact disc (or like medium). Playback only mode is important to allow for control over the distribution of the microchip's content. In order to disable this feature, the content will not have access to an encryption key code which will be located on digital multimedia devices. Additionally, this invention can allow for the multimedia chip's content to be automatically persisted to a personal computer if needed, similar to the way it is persisted onto a digital multimedia device.

Another claim for the present invention is for multimedia chips to come complimentary with compact discs (or like medium). With the current systems, a user can purchase a compact disc with uncompressed audio or video. These files must be converted into compressed digital data then placed on the device using a host system. This current method involves multiple steps that some users do not understand, or may not wish to do. The present invention will enable the distributors of the content to distribute a compressed digital version of the content on multimedia chips along with the uncompressed audio or video compact disc.

The primary advantage of the present invention is that it provides a system and method for a secure method of automatically transferring digital data onto a digital multimedia device while also enabling the playback of the files on a host system. Other advantages of the present invention include: (1) the introduction of a new distribution means for audio and video content; (2) increased control over how many digital multimedia devices digital data can be installed on (3) using encryption keys, increased security surrounding the copying and playback of digital data.

These are just a few of the many advantages of the present invention, as described in more detail below. As will be appreciated, the invention is capable of other and different embodiments, and its several details are capable of modifications in various respects, all without departing from the spirit of the invention. Accordingly, the drawings and descriptions of the preferred embodiments set forth below are to be regarded as illustrative in nature and not restrictive.

### BRIEF DESCRIPTION OF THE DRAWINGS

The present invention satisfies the needs noted above as will become apparent from the following description when read in conjunction with the accompanying drawings wherein:

FIG. 1 is a system diagram showing the persistence and playing of the digital data items from the multimedia chip to the user's digital multimedia device, where the automation program is operating on both the digital multimedia device and the multimedia chip.

### DETAILED DESCRIPTION OF THE DRAWINGS

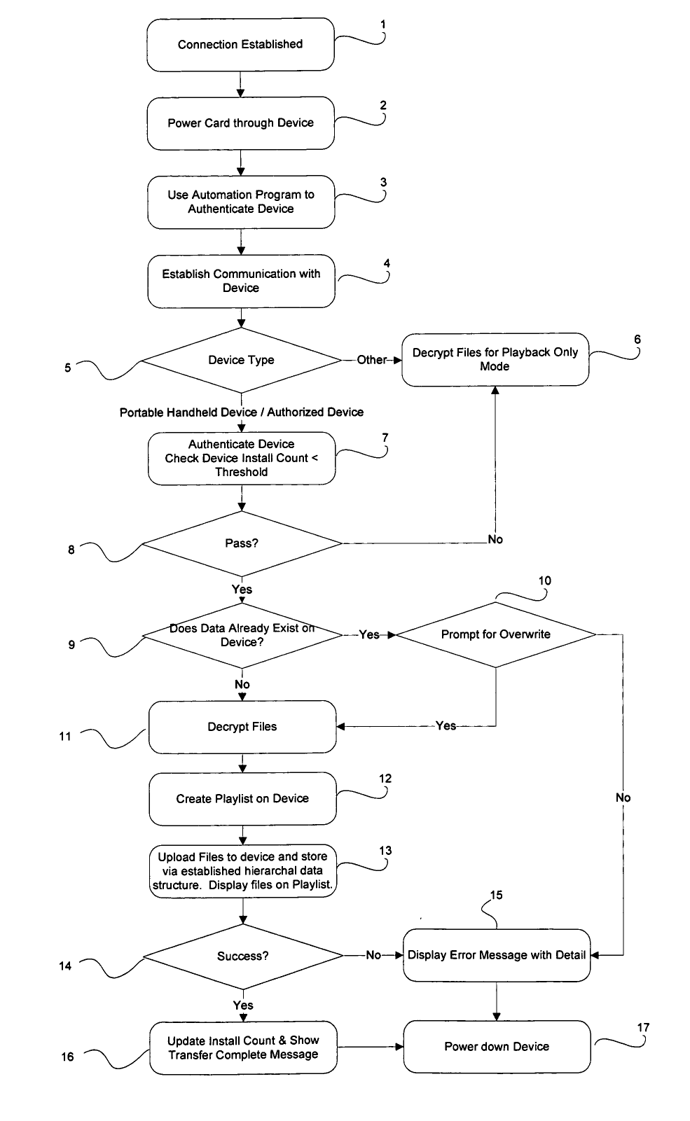

Referring now to the drawings, FIG. 1 is a flow chart showing the steps carried out by the automation software 3 operating on the multimedia chip 19, and the steps carried out by the digital multimedia device in order to interface with the multimedia chip. The automation program 3 is started by the detection of power 2. Power 2 is obtained by using the power from the digital multimedia device 5. Once the automation software 3 is initialized, it interfaces with the connected device 4 to determine what type of device it is 5. If the device type is a Portable Handheld or an authorized device, then it begins the transfer process. If the device is not a Portable Handheld or an unauthorized device, the microchip is to decrypt the files for playback mode only 6.

As previously stated, the transfer process begins once the device type is recognized as a portable handheld or an authorized device. The transfer process first authenticates the device as genuine and checks that the transfer count is less than five 7. If the transfer count is greater than or equal to five, it unlocks the digital multimedia files for decryption and playback mode only 6. If the transfer count is less than five, it detects whether or not the digital multimedia files already exist on the device 9. If the digital multimedia files already exist on the device, it prompts the user as to whether or not he or she would like to overwrite the existing multimedia files 10. If they choose not to overwrite, the process ends with an error message 15. If the user chooses yes or the files do not already exist on the device then decrypt digital multimedia files for transferring 11. Once the files are decrypted and ready to be transferred, create a playlist 12 on the device. This step is optional, depending on what type of media is being transferred. The next step is to extract the files onto the device by persisting the data into the established hierarchal data structure of the device 13. If this is successful 14, update the transfer count and display a transfer successful message 16 and power down the chip 17. If the transfer fails, display an error message with the error 15 and power down the chip.

What is claimed:

1. A system for persisting digital multimedia data from an external memory unit onto a digital device's memory unit, comprising of the following steps:
upon coupling of the external memory unit to the digital multimedia device, launch a decryption module for decrypting the digital multimedia data from the external memory unit with the encryption key to generate a decrypted copy of the digital multimedia data for persisting the encrypted digital multimedia data to the digital device's memory unit;
if the encryption key is not valid, enable the digital multimedia data for playback only as long as the said devices are coupled;

2. The external memory unit of claim 1, further comprising:
encrypted or decrypted, compressed or uncompressed digital audio, video, text, or speech files stored onto a flash memory unit.

3. The digital multimedia device of claim 1, further comprising:
a multimedia device which utilizes a disk drive for data storage.

4. The inclusion of said external memory unit with an audio compact disc or digital video disc.
